(19) United States
(12) Patent Application Publication
(10) Pub. No.: US 2004/0013135 A1
(43) Pub. Date: Jan. 22, 2004

(54) System and method for scheduling traffic in wireless networks

(76) Inventor: Yoram Haddad, Beer Sheva (IL)

Correspondence Address: KATTEN MUCHIN ZAVIS ROSENMAN, 575 MADISON AVENUE, NEW YORK, NY, 10022-2585, US

(21) Appl. No.: 10/196,992

(22) Filed: Jul. 17, 2002

(51) Int. Cl. H04J 1/02

(52) U.S. Cl. 370/493; 370/349

(57) ABSTRACT

The present invention provides a new transmission method for both voice and data packets as an enhancement of IEEE 802.11 protocol of wireless LAN network, which includes access point station (AP) and wireless stations. This method utilizes the transmission of standard beacon packets for embodying allocation information. The allocation information and transmission cycle are determined according to various criteria, among them packet's type and the traffic congestion. The transmitted allocation information includes scheduling information of reserved transmission periods for voice or data packets of both wireless and AP stations. For each wireless station voice session at least two time slots are reserved within each transmission cycle: one for uplink transmission of voice packets from the wireless station to the AP station and a second one for downlink transmission of voice packets from the AP station to the wireless station.

### BACKGROUND OF THE INVENTION

1. The Scope of the Invention

This invention relates to the traffic scheduling protocol of wireless networks, and in particular to the scheduling mechanism which is an enhancement of the IEEE 802.11 protocol.

2. Abbreviations & Definitions

| | |
|---|---|
| Ack | Acknowledgment: confirmation for packet reception |
| AP | Access Point: Any entity that has station functionality and provides |
| | access to the distribution services |
| BBS | Basic service set: set of stations controlled by a single |
| | coordination function. |
| CF | Contention free |
| DCF | Distributed Co-ordination Function: A class of coordination |
| | function where the same coordination function logic is active |
| | in every station in the basic service set (BSS) whenever the |
| | network is in operation. |
| FH | Frequency hopping |
| LAN | Local Area Network |
| MAC | Medium Access Control. |
| NAV | Network allocation vector: An indicator, maintained by each |
| | station, of time periods when transmission onto the wireless |
| | medium (WM) will not be initiated by the station whether or not |
| | the station's clear channel assessment (CCA) function senses |
| | that the WM is busy. |
| PHY | Physical layer |
| PIFS | point (coordination function) interframe space |
| WAN | Wide area network |
| SIFS | Short inter-frame space |
| St | Station |

3. Prior Art

With the development of high performance portable personal computers and the necessity for networking among various computing machines, the implementation of a wireless local area network has become a “hot” issue. A successful implementation of a wireless LAN involves, among other things, a successful development of physical layer (PHY) for transmissions through radio or infrared, and of an effective and efficient medium access control (MAC) protocol.

Due to great market demand, the IEEE Computer Society has formed a standard study group IEEE 802.11 Wireless LANs to standardize the high-speed wireless local area networks. The goal of IEEE 802.11 is to define the physical transmission specification and medium access control scheme. After several years of study, appropriate medium access control (MAC) for wireless LANs still remains open to improvements.

In the 802.11 protocols, the fundamental mechanism to access the medium is called distributed coordination function (DCF). This is a random access scheme, based on the carrier sense multiple access with collision avoidance (CSMA/CA) protocol. Retransmission of collided packets is managed according to binary exponential back off rules.

In the implementation of IEEE 802.11 WLAN protocol, the beacon packet is transmitted periodically by the Access Point (AP) to allow stations (STAs) to locate and identify the Basic Service Set (BSS).

As a result of the IEEE study, the transmission mechanism has been standardized as follows (according to 802.11): before transmitting a packet, a station operating in RTS/CTS mode “reserves” the channel by sending a special Request-To-Send short packet. The destination station acknowledges the receipt of RTS packets by returning a Clear-To-Send packet (CTS). After a station receives the CTS packet normal packet transmission and ACK response take place.

The RTS and CTS packets carry the information of the length of the packet to be transmitted. Any active stations can read this information and update their network allocation vector (NAV), which contains information of the period of time in which the channel will remain busy.

The transmission of RTS packet may create unavoidable collisions which cause interruptions in the transmitting channel and create unpredictable delays and jitters. Such delays may cause significant disturbance in voice sessions.

Moreover, the transmission method as described above is not suitable for voice packets. As Voice packets have very small payload, the overhead transmission periods spent on RTS and CTS packets result in an inefficient transmission.

Therefore, it is the primary object of this invention to avoid the limitations of the prior art and provide a new transmission procedure enabilng efficient and undisturbed transmission of both voice and data packets.

### SUMMARY OF THE INVENTION

According to the present invention is suggested a transmission method for both voice and data packets as an enhancement of IEEE 802.11 protocol of wireless LAN network, which includes access point station (AP) and wireless stations, said method utilizing the transmission of standard beacon packets for embodying allocation Information.

The present invention provides a management system for controlling voice sessions and data packets transmission in wireless LAN network, as an enhancement of IEEE 802.11 protocol, said system comprise: a central coordination module utilizing beacon packets for determining allocation transmission information and transmission cycle; and schedule transmissio module at each network station.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is an illustration of the environment in which the present invention is practiced;

FIG. 2 is a representation of the of prior art transmission protocol;

FIG. 3 illustrates the beacon packet content according to the present invention;

FIG. 4 is an example of a transmission session according to the present invention;

FIG. 5 illustrates the transmission processing states according to the present invention;

### DETAILED DESCRIPTION OF THE PREFERRED EMBODIMENT

The present invention provides a new methodology for allocating transmission time between wireless stations in a wireless network. This methodology in an enhancement of the IEEE 802.11 protocol.

In the term “Station” (St) it's meant to include both access point stations and wireless stations.

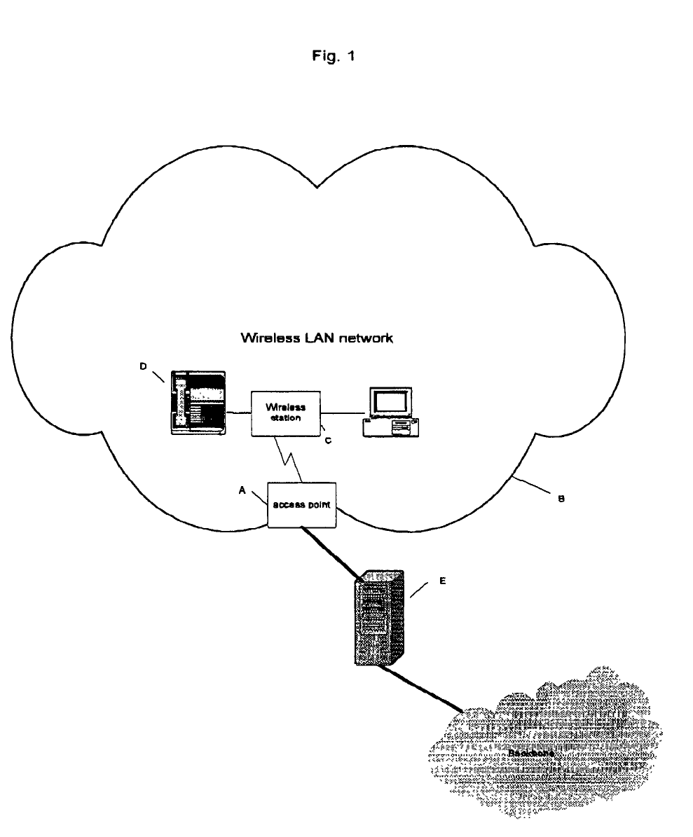

FIG. 1 illustrates the environment in which the present invention is practiced. AP station (A) serves as access point (AP) for wireless LAN network (B). The wireless stations C, such as desktops, notebooks or stand-alone unit, provide communication to phone D. This AP station is further connected through gateway server E to external networks such as the Internet.

According to the first embodiment of the present invention, the scheduling method is mainly adapted for voice data transmission. The new scheduling procedure is based on the correlation between the cycle periods of beacon packets transmission (“transmission cycle”) and the intervals between voice data packets transmission.

The original role of the beacon packets is to enable all wireless stations to locate and identify the Basic Service Set (BSS).

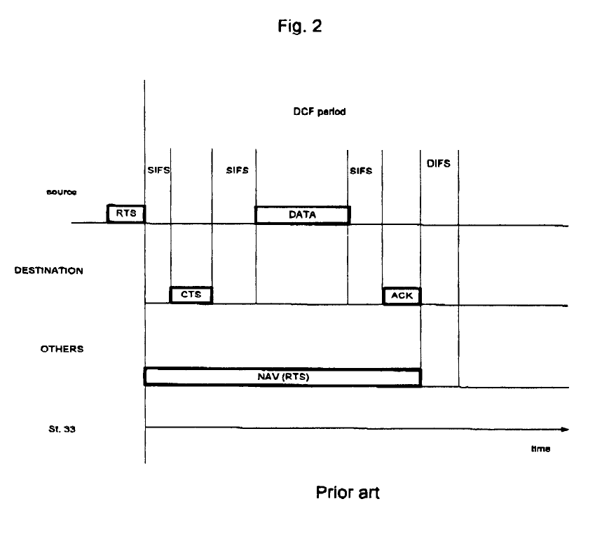

According to prior art transmission protocol each wireless station has to ask the AP station for permission before transmitting by sending RTS (Request to send) messages and wait until it receives confirmation of CTS (clear to send packet). (See FIG. 2)

It is known that voice packets transmission have predictable constant intervals and their payload size is very small. Thus it is suggested according to the present invention to eliminate the RTS and CTS messages and instead to schedule pre-determined time intervals for each wireless station having an active voice session.

As mentioned above, since the intervals between transmission of successive beacon packets on the one hand and the (expected) intervals between arrival of successive voice packets on the other can be made identical, the beacon packet may be used for informing the wireless stations of the respective time periods reserved for each station.

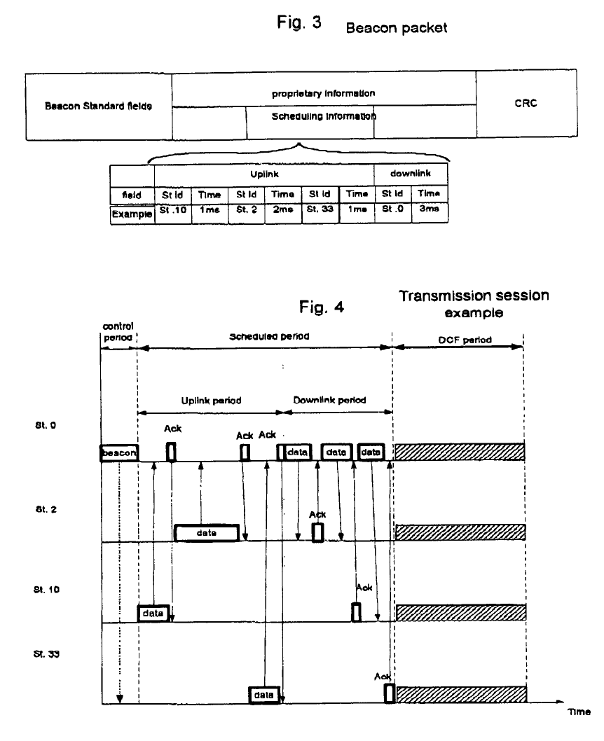

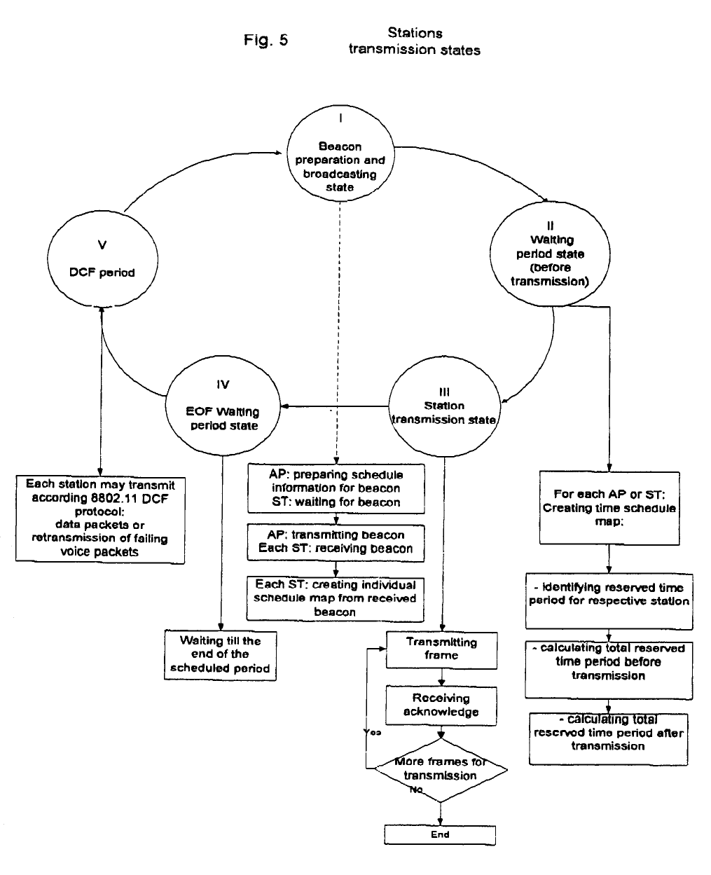

The beacon packet structure according to the present invention is illustrated in FIG. 3. The modified beacon packet further includes scheduling information of each active station ID and the respective reserved transmission period. The schedule data order determines the actual transmission order. An example of a transmission cycle period and scheduling allocation is illustrated in FIG. 4 as follows:

Control Period: During this period the AP broadcast Beacon, which includes bandwidth allocation maps of the corresponding scheduled periods. The transmission of other packets is prohibited during such period, in order to ensure the beacon broadcasting.

Scheduled period: during this period both AP and wireless stations are transmitting according to the scheduling information. This period is divided into two periods; Uplink period and downlink period.

Uplink Period: During this period, the AP station doesn't transmit data but just receives packets sent by the wireless stations. As seen in the example: The AP allocates transmission windows for each wireless station according to the call bandwidth requirements, which are received upon the call initiation, for example station 10 transmits for 1 milliseconds, station 2 transmits for 2 milliseconds, and so forth.

Downlink Period during this period, the AP station transmits packets to wireless stations according to the scheduled transmission.

At the end of transmission cycle, a DCF Period is allocated, enabling all stations to transmit data or voice packets according to the known DCF transmission mechanism.

FIG. 5 illustrates the operative states of the active stations: In the first state (I) the AP station broadcasts the beacon packet and all other stations are idle waiting for the beacon packet's reception. At the second state (II) each station identifies the allocation information and maps the scheduled periods according to the three following phases: waiting time before transmission, reserved transmission period and waiting time after transmission until the end of the transmission cycle.

State three (III) is the actual transmission period of each specific station, during which each station transmits its packets and receives acknowledgement in return. At stage IV the station is idle waiting until the end of the scheduled transmission period. During this period the transmission is prohibited, the stations can only receive packets from the AP station.

During Stage V, the DCF period, each station may try to transmit data packets or retransmit voice packets, which did not reach their destination during the uplink period.

Once a requirement to establish a voice session is generated, either by an off-hook of a telephone attached to a wireless station, or due to a call coming through the AP (either from other wireless stations on the network, or from the PSTN through a gateway), the wireless station announces to the AP that a call is being established and requests allocation of bandwidth for a voice session. The AP checks the bandwidth availability, and in case of positive reply, an ID number is assigned for the station and two time slots are allocated for this voice session: one for the downlink transmission from the AP station to the wireless station and one for the uplink packets (from the wireless station to the AP). The AP Informs each wireless station of the allocation status through the beacon packet. Incase of failing voice packets, additional time slots can be allocated for their retransmission at the next transmission cycle.

The allocation of both uplink and downlink periods can have the same format, thus uniform programming code can be used, wherein both station types IDs have the same encoding.

As the order of the schedule data reflects the actual transmission order, each wireless station can calculate its starting time by calculating the sum of all preceding stations reserved periods.

As mentioned above, during the transmission cycle, a DCF period is allocated at which time DCF transmission techniques are applied.

Such DCF period can be used for data packets transmission, thus enabling to utilize the transmitting channel for both voice and data types packets. Such methodology optimizes the allocation policy in accordance to the type of incoming traffic as follows: In the event of a voice session initiation, a scheduled transmission period is allocated at the next transmission cycle. In the event of a request to transmit a data type packet, the DCF period is used, thus the stations may transmit according to the known procedure by sending RTS packet to the AP station and receiving CTS at the next DCF period.

Stations which are programmed according to the 802.11 protocol (Old station) can transmit during the DCF period. The intervals between scheduled packets transmission are identical to the SIFS period, thus the old station is not affected by the new transmission procedure scheduling allocation.

The DCF period can be further used for transmission of voice packets which failed to reach their destination. This option is preferably implemented by using ROUND-ROBIN method: each voice data packet, which wasn't replied by ACK, is inserted in queue which acts according to “first in first out” rules, hence after all packets received their chance for transmission, all failing voice packets are retransmitted during the next DCF (Preferably at the last 5 milliseconds) period according to the order of arrival, the packets may be transmitted again and again (one trial at each Transmission Cycle) until they receive the respective acknowledgement.

According to improvement of the present invention it is suggested to use the “Piggy-back” method by utilizing uplink transmission period for transmitting the ACK fields, which confirm the reception of Downlink transmitted packets (instead of transmitting them during the downlink period). When using this method the downlink period is scheduled before the uplink period.

According to the first alternative of the present invention it is suggested that the scheduling information will include the specific transmission start time for each station, instead of the reserved time period. Such scheduling scheme enables to allocate flexible transmission period which are not necessarily successive.

According to second alternative of the present invention it is suggested to further utilize the beacon packets to carry acknowledgement information. This information includes ACK data for each wireless station. As described above the beacon packet scheduling Information includes reserved time periods for each station, it is suggested to include an additional data field for each wireless station, said data field carrying the ACK information. Alternatively, the ACK information may be transmitted not in the beacon packets but in dedicated packets, which are broadcasted at each transmission cycle.

A further improvement of the new transmission procedure of the present Invention can be achieved by using voice activity detection (VAD) capabilities. Active voice sessions do not necessarily mean that all voice packets contain meaningful information. Frequently, one speaker is silent while another is speaking. Thus, an AP station, which is capable of detecting such silent periods, can save time slot by allocating only one time slot to the respective station when no voice activity is detected.

The scheduled mechanism and the advanced time slot reservation allows predictable delay and very small jitter of the voice packets, thereby allowing toll quality voice to be efficiently implemented in IP based Broadband Wireless Access networks.

Although the allocation method of the present invention is adapted to voice packets, it is further suggested to utilize this allocation mechanism for data type packets as well. The requests of wireless stations for transmitting new data packets are processed during the DCF period by sending RTS request. According to the normal procedure, the wireless station waits for CTS message before transmitting. According to the present invention, it is suggested to allocate the respective station scheduled transmission time within the uplink period. The wireless station is informed of this allocation by the beacon packet or alternatively by dedicated packet. The scheduling information format is similar to the format of voice packets scheduling information. When allocating the transmission periods for data packets only one time slot is required (unlike voice sessions which requires two time slots). The time slot duration is determined in proportion to the packet length.

While the above description contains many specifications, they should not be construed as limitations within the scope of the invention, but rather as exemplifications of the preferred embodiments. Those that are skilled in the art could envision other possible variations. Accordingly, the scope of the invention should be determined not only by the embodiment illustrated but also by the appended claims and their legal equivalents.

What is claimed is:

1. A transmission method for both voice and data packets as an enhancement of IEEE 802.11 protocol of wireless LAN network, which includes access point station (AP) and wireless stations, said method utilizing the transmission of standard beacon packets for embodying allocation information.

2. The method of claim 1, wherein the allocation information and transmission cycle are determined according to various criteria, among them packet's type and the traffic congestion.

3. The method of claim 1, wherein the allocation information includes scheduling information of reserved transmission periods for voice or data packets of both wireless and AP stations.

4. The method of claim 3 wherein for each wireless station voice session at least two time slots are reserved within each transmission cycle: one for uplink transmission of voice packets from the wireless station to the AP station and a second one for downlink transmission of voice packets from the AP station to the wireless station.

5. The method of claim 4 wherein time slots are further reserved for re-transmission of failing voice packets.

6. The method of claim 3 wherein the transmission of ACK data packets is performed during the reserved time period immediately after the reception of the data packet.

7. The method of claim 3 wherein the uplink transmission includes ACK fields confirming the reception of the downlink data packets transmission.

8. The method of claim 3 wherein the scheduling information contains pairs of numbers which indicate stations IDs and respective reserved time periods, said sets of numbers are arranged according to scheduled transmission order, accordingly each station starts transmitting its packets at the scheduled time, wherein such scheduled time period is calculated according to the sum of all reserved time periods of the preceding stations.

9. The method of claim 3 wherein the scheduling information contains pairs of numbers which indicate station IDs and specific time for starting transmission, accordingly each station starts transmitting its packets at the respective time.

10. The method of claim 3 wherein the beacon packet further includes information of ACK fields confirming the reception of uplink packets transmission.

11. The method of claim 3 further comprising the step of broadcasting a dedicated packet including ACK fields confirming the reception of uplink packets transmission.

12. The method of claim 1 wherein the allocation Information includes DCF reserved time period within each transmission cycle wherein the DCF distributed coordination function (DCF) mechanism is utilized enabling transmission for stations which are programmed according to standard 802.11 transmission protocol.

13. The method of claim 12 wherein for wireless station requests for data packets transmission during the DCF period, at least one time slot is reserved in the next transmission cycle.

14. The method of claim 12 wherein the DCF period is reserved for transmission of data packets.

15. The method of claim 12 wherein the DCF period is further reserved for transmission of voice packets, which fail to reach their destination.

16. The method of claim 15 wherein the transmission order of failing voice packets is determined according to the original transmission order, enabling single retransmission of failing voice packets at each transmission cycle.

17. The method of claim 3 wherein for each wireless station voice session at least one time slot is reserved within each transmission cycle for uplink transmission of voice packets from the wireless station to the AP station and if voice packets are detected as active, then at least one time slot is reserved within each transmission cycle for downlink transmission of voice packets from the AP station to the wireless station.

18. A management system for controlling voice sessions and data packets transmission in wireless LAN network, as an enhancement of IEEE 802.11 protocol, said system comprising:
central coordination module utilizing beacon packets for determining allocation transmission information and transmission cycle; and
schedule transmission module at each network station.

19. The system of claim 18 wherein the allocation information is determined according to various criteria, among them packets' type and traffic congestion.

20. The system of claim 18 wherein allocation information includes scheduling information of reserved transmission period for all wireless and AP stations

21. The system of claim 20 wherein the coordination module reserves at least two time slots within each Transmission Cycle for each station voices session: one for uplink transmission of data packets from the wireless station to the AP and a second one for downlink transmission of data packets from the AP station to the wireless station.

22. The system of claim 21 wherein time slots are further reserved for re-transmission of failing voice packet.

23. The system of claim 20 wherein the transmission of ACK packets is performed during the reserved time period immediately after the reception of the data packet.

24. The system of claim 20 wherein the uplink transmission includes ACK data fields confirming the reception of the downlink data packets transmission.

25. The system of claim 20 wherein the scheduling information contain pairs of numbers which indicate station IDs and respective reserved time period, wherein said sets of numbers are arranged according to scheduled transmission order, accordingly each station transmission module calculates the scheduled time period according to the sum of all reserved time period of the preceding stations and starts transmitting the voice packets at the respective time period.

26. The system of claim 20 wherein the scheduling information contains pairs of numbers which indicate station IDs and specific start time for transmission, accordingly each station transmission module identifies the respective schedule time and starts transmitting the station voice packets accordingly.

27. The system of claim 20 wherein the beacon packet further includes ACK fields confirming the receipt of uplink packets transmission.

28. The system of claim 20 wherein the coordination module further broadcasts a dedicated packet including ACK fields confirming the reception of uplink packets transmission.

29. The system of claim 18 wherein the coordination module further enables allocation of DCF reserved time period within each transmission cycle wherein the distributed coordination function (DCF) mechanism is utilized, enabling transmission for stations which are programmed according to standard 802.11 transmission protocol.

30. The method of claim 29 wherein for station requests for data packets transmission during the DCF period is reserved at least one time slot at the next transmission cycle.

31. The system of claim 29 wherein the DCF period is reserved for transmission of data packets.

32. The system of claim 29 wherein the DCF period is reserved for transmission of voice packets, which fail to reach their destination.

33. The system of claim 32 wherein the transmission order of failing voice packets is determined according the original transmission order, enabling single retransmission of failing voice packets at each transmission cycle.

34. The system of claim 20 wherein the coordination module reserves for each wireless station voice session, at least one time slot within each transmission cycle for uplink transmission of voice packets from the wireless station to the AP station, and if voice packets are detected as active, then additionally reserves at least one time slot within each transmission cycle for downlink transmission of voice packets from the AP station to the wireless station.
